(19) United States
(12) Patent Application Publication
(10) Pub. No.: US 2005/0149739 A1
(43) Pub. Date: Jul. 7, 2005

(54) PIN verification using cipher block chaining

(75) Inventors: W. Dale Hopkins, Georgetown, KY (US); Steven W. Wierenga, Hillsborough, CA (US); Ching-Hsuan Chen, Fremont, CA (US); Jack Schifando, Scotts Valley, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P., Houston, TX (US)

(21) Appl. No.: 10/749,200

(22) Filed: Dec. 31, 2003

(51) Int. Cl. H04K 1/00

(52) U.S. Cl. 713/184

(57) ABSTRACT

A PIN verification apparatus comprises a plurality of cipher blocks linked in a Cipher Block Chain (CBC) and keyed with a secret PIN Verification Key (PVK). A first input block is coupled to a first cipher block in the CBC chain and is configured to receive a plaintext block derived from a secret PIN. A second input block is coupled to a second cipher block in the CBC chain capable of receiving a plaintext block derived from a non-secret entity-identifier and ciphertext from a cipher block in the CBC chain.

### BACKGROUND OF THE INVENTION

Each day in the United States alone over 100 million transactions aggregating $5 Billion are authorized and initiated by cardholders at over 400,000 Automated Teller Machines (ATMs) and seven million Point-of-Sale (POS) terminals. Securing the massive daily financial flow against fraud and loss relies upon protecting and verifying cardholder Personal Identification Numbers (PINs) using methods, structures, and cryptographic algorithms originating over twenty-five years ago.

Data security systems, such as financial systems, use security techniques and systems originating in the early 1980s that were based on technologies created in the late 1970s. Computational power, cryptanalytic knowledge, breadth of targets, and creative ingenuity accessible to potential attackers have grown dramatically since origination of the systems, while defensive technologies have scarcely evolved.

The Personal Identification Number (PIN) is a basic construct for establishing identity and authorization or consumer financial transactions. In a typical transaction, a PIN is used in finance industry applications to authorize an electronic funds transaction initiated by an entity such as a customer. A magnetic stripe card or smart card is intended for usage to identify the customer in combination with a PIN that is known to the customer but otherwise is secret.

Current PIN verification techniques are now known to be cryptographically weak, resulting in a PIN security vulnerability that even exceeds weaknesses in underlying keys and algorithms. These weaknesses can be attacked by an adversary, potentially resulting in a loss of data security.

Present-day financial and commercial transaction systems predominantly use cryptographic algorithms with known weaknesses. Security difficulties afflict several techniques. One technique determines a PIN offset as a modulus 10 difference of a natural PIN and a customer-selected PIN. The natural PIN is formed by receiving the first leftmost bits of the output data from a Data Encryption Standard algorithm. Another algorithm uses the same algorithm with parameters which select the natural PIN beginning with any digit in the hexadecimal output.

One difficulty is that the single Data Encryption Standard (DES) key used in techniques is too short (56 bits) to attain adequate security. In addition, the first technique is unforgiving if a PIN is compromised. Another problem is that the input data to the algorithm is not secret.

A difficulty with existing handling relates to the relationship of the natural PIN, the entered PIN, and the PIN offset. If a PIN is compromised, then an adversary can use the PIN offset to compute a new PIN chosen by the customer. Accordingly, selection of the new PIN does not attain security once a PIN is compromised. The only way to recover security is for the bank or other issuing entity to change either the customer account number or the bank's PIN verification key. Changing the customer account number is difficult for the bank, and changing the PIN verification key is even more difficult. Accordingly, an easy attack against that PIN is available.

### SUMMARY

In accordance with an embodiment of a data security system, a PIN verification apparatus comprises a plurality of cipher blocks linked in a Cipher Block Chain (CBC) and keyed with a secret PIN Verification Key (PVK). A first input block is coupled to a first cipher block in the CBC chain and is configured to receive a plaintext block derived from a secret PIN. A second input block is coupled to a second cipher block in the CBC chain capable of receiving a plaintext block derived from a non-secret entity-identifier and ciphertext from a cipher block in the CBC chain.

### BRIEF DESCRIPTION OF THE DRAWINGS

Embodiments of the invention relating to both structure and method of operation, may best be understood by referring to the following description and accompanying drawings.

FIGS. 1A and 1B are schematic block diagrams that illustrate embodiments of a system capable of improved Personal Identification Number (PIN) verification using a magnetic stripe card.

FIG. 2 is a flow chart showing an embodiment of a technique or method of Personal Identification Number (PIN) verification.

FIG. 3 is a flow chart illustrates an embodiment of a PIN verification method in reversible form, showing other aspects of the technique.

FIG. 4 is a flow chart depicting an embodiment of a technique for irreversible triple-DES PIN verification.

FIGS. 5A, 5B, and 5C are schematic block diagrams that show different operations of an illustrative embodiment of a PIN security system.

FIG. 6 is a schematic block diagram that illustrates an embodiment of a data security system with a capability to execute PIN verification using magnetic stripe cards.

FIG. 7 is a schematic block diagram that depicts an embodiment of a transaction system capable of using a magnetic stripe card for Personal Identification Number (PIN) verification.

### DETAILED DESCRIPTION

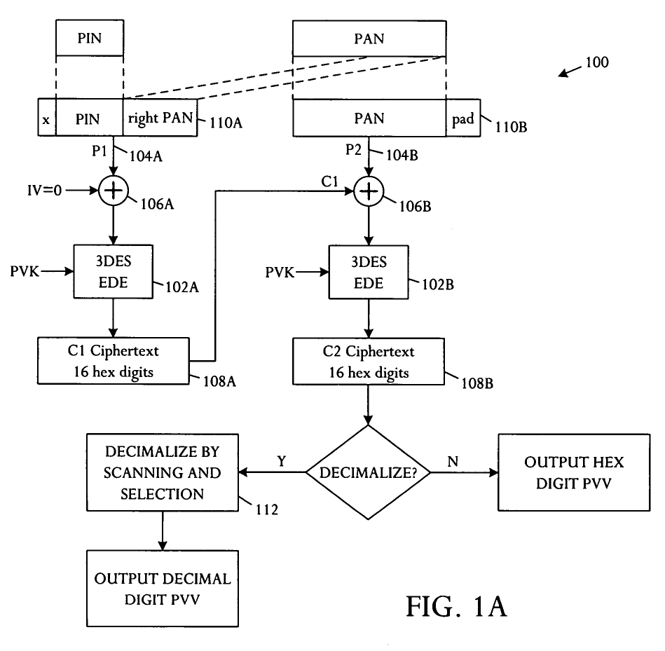

Referring to FIG. 1A, a schematic block diagram illustrates an embodiment of an apparatus 100 capable of improved Personal Identification Number (PIN) verification using a magnetic stripe card. The PIN verification apparatus 100 comprises a plurality of cipher blocks 102A, B linked in a Cipher Block Chain (CBC) and keyed with a secret PIN Verification Key (PVK). A first input block 104A is coupled to a first cipher block 102A in the CBC chain and is configured to receive a text block derived from a secret PIN. A second input block 104B is coupled to a second cipher block 102B in the CBC chain capable of receiving a text block derived from a non-secret entity-identifier and ciphertext from a cipher block 102A, B in the CBC chain. Typically, a customer enters the secret PIN to the apparatus 100, for example using keys on a terminal. The PIN is commonly entered as a numeric string of digits, for example four to twelve digits. The entity-identifier, or account number (PAN), is typically too large for a human to conveniently enter at a keyboard and is therefore encoded on a magnetic stripe card.

In an illustrative embodiment, the PIN verification apparatus 100 can further comprise a logical operator 106A that exclusive-ORs the plaintext block derived from the secret PIN with an initialization vector (IV) to produce an initialized block. A first encryptor cipher block 102A encrypts the initialized block, for example using triple Data Encryption Standard (3-DES) encryption, to produce a first ciphertext block C1 108A. A logical operator 106B exclusive-ORs the plaintext block derived from the non-secret entity-identifier with the first ciphertext block C1 108A to produce a chained block. A second cipher block encryptor 102B encrypts the chained block, for example using triple Data Encryption Standard (3-DES) encryption, to produce a second ciphertext block C2 108B.

Although the illustrative embodiment includes a plurality of cipher blocks 102A, B that encrypt data according to a triple Data Encryption Standard (3-DES), in other embodiments the cipher blocks 102A, B may encrypt data according to other definitions including, for example, an Advanced Encryption Standard (AES) definition. Triple Data Encryption Standard (3-DES) is a higher security encryption technique based on the Data Encryption Standard (DES) described in Federal Information Processing Standards (FIPS) Publication 46-2, of Jan. 15, 1977. Triple DES is simply three DES encryptions in a sequence, commonly with three different keys. American National Standards Institute (ANSI) X9.52 standard defines triple-DES encryption with keys k₁, k₂, k₃ as C=Eₖ, (Dₖ_{₂} (Eₖ_{₁} (M))), where Eₖ and Dₖ denote DES encryption and decryption, respectively, with the key k. The mode of encryption is sometimes called DES-EDE. Another variant is DES-EEE with three consecutive encryptions. Advanced Encryption Standard (AES) is described in Federal Information Processing Standards (FIPS) Publication 197, of Nov. 26, 2001.

Implementation of the AES definition causes the encryption block size to increase from 16 hexadecimal digits to 32 hexadecimal digits. Using an Electronic CookBook (ECB) mode of AES encryption enables inclusion of all PIN and account number information in plaintext blocks P1 and P2.

The PIN verification apparatus 100 can further comprise formatters that format plaintext for application to the cipher blocks 102A, B. In an illustrative embodiment, a first formatter 110A is configured to construct a first incoming plaintext block from a concatenation of a length digit and x hexadecimal digits of the secret Personal Identification Number (PIN) with 16−(x+1) rightmost hexadecimal digits of the non-secret entity-identifier. A second formatter 110B is configured to construct a second incoming plaintext block from a concatenation of y hexadecimal digits of the non-secret entity-identifier, such as a Primary Account Number (PAN), with a pad character that is repeated 16-y times.

The number of digits x in the PIN is typically in a range from four to twelve. The length value is a hexadecimal character representing the length of the PIN. For example, if the PIN length is 12, then the length is a hexadecimal value ‘C’. The number of digits y in the PAN is normally 14-16. The right PAN is the rightmost 16−(x+1) digits of the PAN. The pad is the predetermined pad digit or digits that are applied if y is less than sixteen.

The first formatter 110A receives a one digit PIN length and the Personal Identification Number (PIN), a secret value that is either generated or entity-selected, for example customer-selected, for enrollment. Typically, the customer enters the PIN and a keypad supplies the PIN length. After enrollment and during a customer transaction, the PIN is entered at a terminal for verification.

The second formatter 110B receives an entity-identifier, such as the Primary Account Number (PAN). The entity-identifier is padded with a fixed hexadecimal character, for example ‘A’, to produce a length of 16 hex characters for triple-DES. Similar padding in the case of Advanced Encryption Standard extends the entity-identifier to 32 hex characters. The entity-identifier is non-secret and, in many systems, is stored on a magnetic stripe card for usage in a transaction.

The PIN verification apparatus 100 can include a format converter 112 coupled to a cipher block 102A, B in the CBC chain that is capable of converting hexadecimal digit ciphertext to a decimal result by scanning the hexadecimal digit ciphertext, selecting a predetermined number of numeric digits, and generating output digits as a PIN Verification Value (PVV). Decimalization can be performed using any reasonable or substantially unbiased decimalization algorithm, which does not use a decimalization table. In some conditions, the PVV can be in the form of a specified number of hexadecimal digits. Whether in decimal or hexadecimal form, the number of output digits is typically at least twelve, the length of the longest PIN.

The PIN Verification Value (PVV) can be recorded on the magnetic stripe card and can be sent via network to a server or host where PIN verification is performed. If the PVV is not recorded in the magnetic stripe card, then the PVV can be stored on a database at the server where PIN verification takes place. The server sends an acknowledgement and permission to proceed with the transaction for an approved verification, or sends denial of permission.

The illustrative PIN verification apparatus 100 operates in a reversible mode that enables an issuer, such as an issuer bank, to securely recover an entity's secret PIN, such as a customer PIN, if desired according to the issuer's PIN management policies.

Referring to FIG. 1B, a schematic block diagram illustrates an alternative embodiment of an apparatus 120 capable of improved Personal Identification Number (PIN) verification using a magnetic stripe card and that operates in an irreversible mode. In addition to the formatters 110, the cipher blocks 102A, B, logical operators 106, and format converter 112 of the apparatus 100, the alternative embodiment PIN verification apparatus 120 further comprises a logical operator 122 that exclusive-ORs the first ciphertext block C1 108A with the second ciphertext block C2 108B to produce a third ciphertext block C3 124.

The alternative embodiment PIN verification apparatus 120 operates in an irreversible mode so that, after enrollment, the PIN cannot be recovered by techniques other than an exhaustive PIN search. The irreversible mode may have an option at enrollment to escrow data, enabling recovery of an entity PIN in a secure off-host operation. In the illustrative embodiment, the PIN verification apparatus 120 further comprises a PIN escrow processing block 126 coupled to receive ciphertext C2 108B from the cipher block 102B. The PIN escrow processing block 126 provides the option for the second ciphertext block C2 108B to be split into one or more secret shares. The shares can be supplied to multiple different databases, for example A1 and A2. Division of secure data into multiple parts increases security. PIN escrow storage 128 stores escrow data from the PIN escrow processing block 126.

In irreversible mode, even if all sixteen digits of the third ciphertext block C3 124 are retained as a PIN Verification Value (PVV), the PIN is generally only retrievable by using the ciphertext block C2 escrow.

Selection between reversible and irreversible mode is optional, depending on the security policies of an organization supporting the cards. Some institutions may wish to recover the PIN for various purposes.

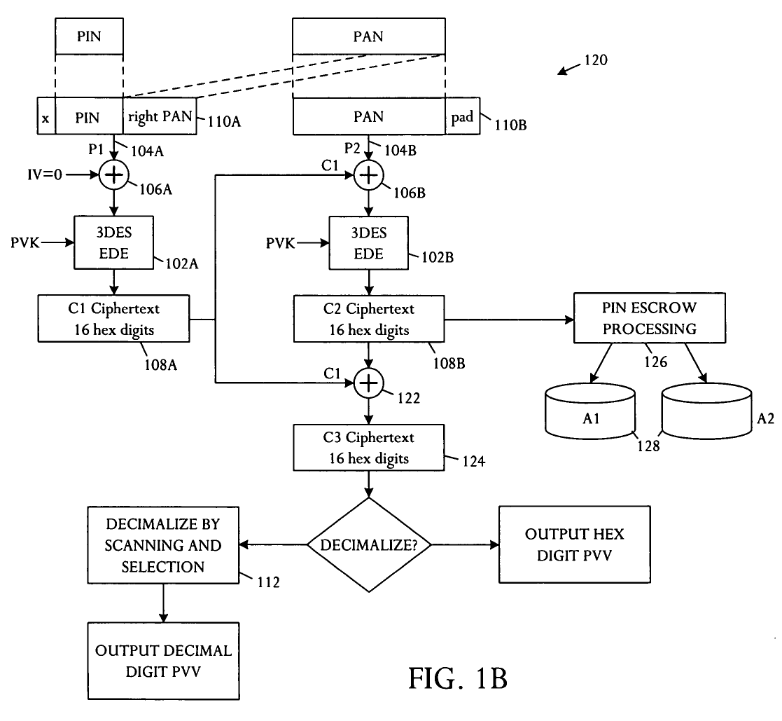

Referring to FIG. 2, a flow chart illustrates an embodiment of a technique or method of Personal Identification Number (PIN) verification 200 comprising the actions of linking a plurality of cipher blocks in a Cipher Block Chain (CBC) 202, applying an incoming plaintext block derived from a secret Personal Identification Number (PIN) to one of the plurality of cipher blocks 204, and applying an incoming plaintext block derived from a non-secret entity-identifier and ciphertext from a cipher block in the CBC chain 206. The cipher blocks are keyed 208 with a secret PIN Verification Key (PVK). The method further comprises executing the cipher blocks 210 resulting in generation of ciphertext.

In a Cipher Block Chain (CBC), results from an encryption block are fed back to the input block of the next encryption block. Each encryption block in the chain receives plaintext input data, which is exclusive-Ored with results from the previous cipher-text block, then encrypted. As a result, encryption of each block depends on results from all previous blocks. Accordingly, a corresponding decryption side processes all encrypted blocks sequentially using a random initialization vector that is exclusive-OR'ed with the first data block before encryption.

The initialization vector can be public or secret. In various embodiments, the initialization vector can be a random number or a serial number, to ensure unique encryption of each message. An encryption error, for example due to transmission failure, garbles the block with the error and causes bit errors in the subsequent block at the same positions as the original erroneous block. Subsequent blocks are not affected by the error so that CBC is self-recovering from bit errors, although not from synchronization errors. Bits added or deleted from the cipher-text stream cause garbling of all subsequent blocks.

The Cipher Block Chaining Message Authentication Code (CBC MAC) specifies that a message x=x₁, . . . , xₘ can be authenticated among parties who share a secret key a by tagging x with a prefix of:
fₐ^{m}(x)=fₐ(fₐ(. . . fₐ(fₐ(x₁)xor x₂)xor . . . xor xₘ₋₁)xor xₘ),
where f is an underlying block cipher, such as an encryption definition or standard, and a is a secret key.

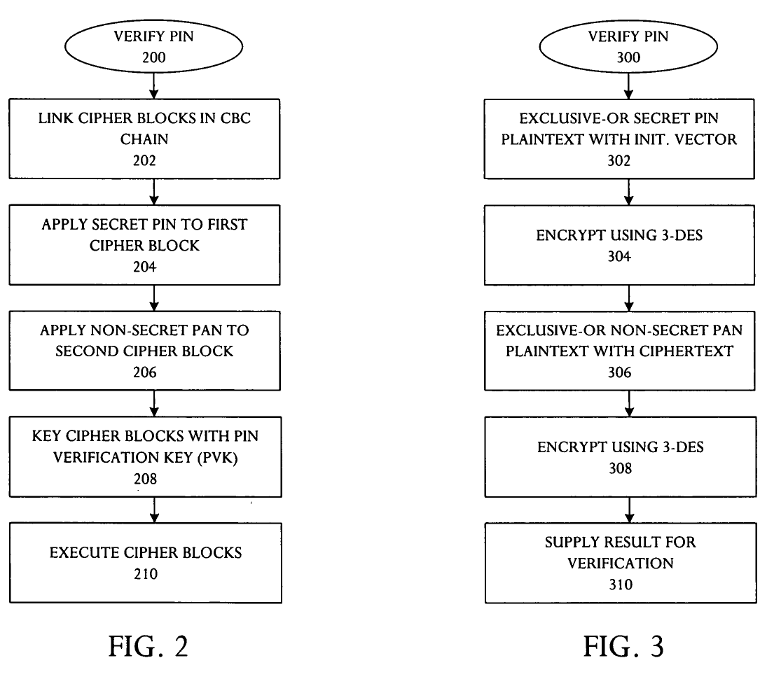

Referring to FIG. 3, a flow chart illustrates an embodiment of a PIN verification method 300 in reversible form, showing other aspects of the technique. The method comprises actions of exclusive-ORing 302 a plaintext block derived from a secret PIN with an initialization vector to produce an initialized block, and encrypting the initialized block 304 using triple Data Encryption Standard (3-DES) encryption to produce a first ciphertext block C1. The method 300 further comprises exclusive-ORing 306 a plaintext block derived from the non-secret entity-identifier with the first ciphertext block C1 to produce a chained block, and encrypting the chained block 308 using triple Data Encryption Standard (3-DES) encryption to produce a second ciphertext block C2. The second ciphertext block C2 is supplied 310 for PIN verification.

In an embodiment of a reversible form of PIN verification, a Personal Identification Number (PIN) is presumed to be represented by a PIN length character, x hexadecimal digits, and an entity-identifier or account number, such as a Primary Account Number (PAN), is presumed to include y hexadecimal digits. In the American National Standards Institute (ANSI) financial environment, the PIN is assumed to include no more than twelve hexadecimal digits and the account number has a length of sixteen digits or fewer.

Two plaintext blocks P1 and P2 are formed in which P1 is defined as the concatenation of one digit specifying the PIN length, followed by the x digits of PIN along with the 16−(x+1) rightmost digits of the account number. The resulting plaintext block is 16 hexadecimal digits in length and is thus equal to the block length of the triple Data Encryption Standard (3-DES) algorithm. The second plaintext block P2 is constructed by concatenating the y digits of the account number with a pad character which is repeated 16-y times. The pad character is fixed in the algorithm and is not available as input data to the algorithm. The result is two plaintext blocks P1 and P2, each having a length of sixteen hexadecimal digits.

The PIN verification technique using 3-DES can use Cipher Block Chain (CBC) mode since CBC mode facilitates usage of the full 16-digit length which may be desirable to ensure uniqueness of account numbers.

In some systems or circumstances, for example if a more rapid response or only a single 3-DES cycle is desired, information in the account number may be reduced by hashing down to fewer hexadecimal digits, such as four digits. As an alternative to hashing to reduce the number of digits, the account number may be truncated, for example by selecting only the least significant four account number digits. Accordingly, the PIN and the reduced information relating to the account number can be contained in the single plaintext block P1.

In the triple-Data Encryption Standard (3-DES) input data is effectively encrypted three times. Many techniques can be used for the encryption. In one example, ANSI X9.52 standard defines triple-DES encryption with keys, k₁, k₂, k₃ according to an equation of the form:
C=Eₖ₃(Dₖ₂(Eₖ₁(M))),
where Eₖ and Dₖ denote DES encryption and DES decryption, respectively, with the key k. The encryption mode is sometimes termed DES-EDE. Another encryption variation is termed DES-EEE that comprises three consecutive encryptions. Three keying options are defined in ANSI X9.52 for DES-EDE. In one option, the three keys k₁, k₂, k₃ are independent. In another option, keys k₁ and k₂ are independent while k₁=k₃. In the third option, all three keys are equal, enabling triple-DES backward compatibility with DES.

Although the illustrative embodiment describes a technique using triple-DES encryption, in other embodiments other encryption definitions may be used such as Advanced Encryption Standard (AES) definition, and the like.

The technique 300 can further comprise actions including, for systems and conditions that use a decimal result, converting hexadecimal digit ciphertext generated by a final ciphertext block in the Cipher Block Chain (CBC) to a decimal result by scanning the hexadecimal digit ciphertext, selecting a predetermined number of numeric digits, and generating output digits as a PIN Verification Value (PVV); and using the PVV for PIN verification.

In some circumstances or systems, the PIN Verification Value (PVV) may be supplied in a hexadecimal form. Accordingly, the method 300 may include supplying hexadecimal digit ciphertext generated by a final ciphertext block in the Cipher Block Chain (CBC) as a PIN Verification Value (PVV).

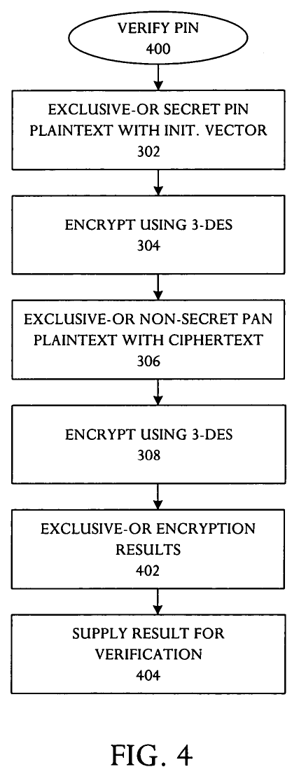

Referring to FIG. 4, a flow chart illustrates an embodiment of a technique for irreversible triple-DES PIN verification 400. The method 400 includes the actions performed in reversible PIN verification 300 but adds a further action, the exclusive-ORing 402 the first ciphertext block Cl with the second ciphertext block C2 to produce a third ciphertext block C3. The third ciphertext block C3 is supplied for PIN verification 404. Combining of the first ciphertext block Cl with the second ciphertext block C2 results in irreversible operation, facilitating PIN management by a transaction institution, such as a bank.

In the irreversible form, the second ciphertext block C2 can be stored in escrow to facilitate recovery of the secret PIN.

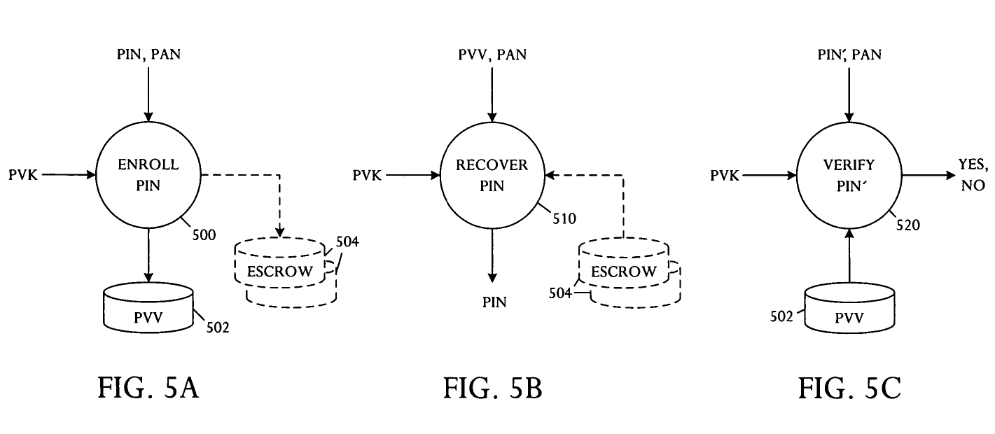

Referring to FIGS. 5A, 5B, and 5C, schematic block diagrams show different operations of an illustrative embodiment of a PIN security system. In the depicted embodiment, each of the three operations can be executed using the PIN handling apparatus 100 and/or 120 based on the Cipher Block Chain (CBC) structure.

A first operation, shown in FIG. 5A, is enrollment of the Personal Identification Number (PIN) at a system 500 adapted for the enrollment process. Data input to the PIN enrollment system 500 from an enrollment terminal include the Personal Identification Number (PIN), for example entered by a customer at a keyboard, and the Primary Account Number (PAN) that is written to the magnetic stripe card. The enrollment system 500 processes the PIN and PAN, keyed by the PIN Verification Key (PVK) and generates the PIN Verification Value (PVV) that is stored in a PVV database 502. For a system that implements the escrow functionality, for example an apparatus 120 as depicted in FIG. 1B, an escrow value can be stored in one or more escrow storage databases 504. Enrollment is typically a one-time event that prepares the magnetic stripe card for subsequent transactions.

Referring to FIG. 5B, a PIN recovery system 510 is shown that can be used to recover a PIN that has been lost or forgotten by a customer. PIN recovery is intended to be a rare operation. The customer PIN is expected to be known only to the customer. The institution that enrolls the customer account and associated magnetic stripe card is generally not to possess the PIN. Therefore, PIN recovery involves communication with the PIN escrow database or databases 504 to supply escrow values in “emergency” conditions. The PIN recovery system 510 operates in the manner of the PIN handling systems 100 and 120, for example using the CBC structure. The PVV database supplies the PVV as stored by the enrolling institution and the PAN can be supplied by the customer's magnetic stripe card. The recovery operation is keyed by the PVK. The escrow 504 supplies the escrow information to enable recovery of the PIN. For example, referring to FIG. 1B, the PVV and PAN can be used to generate ciphertext C1 which is exclusive-ORed with ciphertext C2 that is restored from the escrow values to recover the PIN.

FIG. 5C depicts the PIN verification operation 520, the typical operation that is used for a customer transaction. A customer enters the magnetic stripe card in a card reader and enters an entered Personal Identification Number, depicted as PIN′, generally at a transaction keyboard at a transaction terminal. The terminal generally encrypts the entered PIN′ and PAN information and sends the encrypted information through a transaction network. The encrypted transaction data is received by a host that implements the PIN verification operation 520. The host typically includes a security module that decrypts the encrypted transaction information, including the PIN′ and PAN. The host generally receives the PIN Verification Value (PVV) over the network from the PVV database 502 and performs the PIN verification process 520. The PIN verification process 520 generates a PIN Verification Value, described as PVV′, based on the PIN′ and PAN and compares the PVV′ to the PVV from the PVV database 502. If the PVV values match, then the PIN verification operation 520 asserts that the transaction can proceed. Otherwise, the transaction is denied.

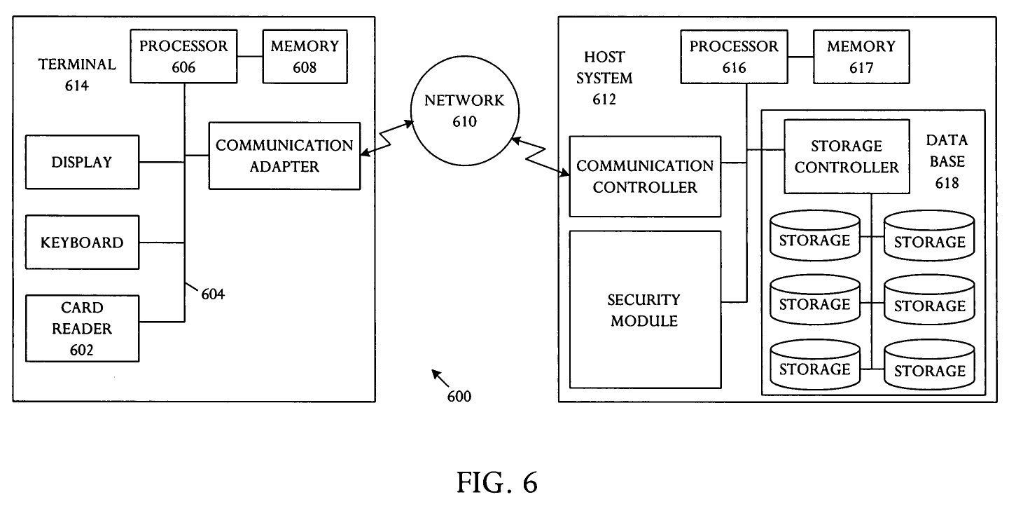

Referring to FIG. 6, a data security apparatus 600 comprising a card reader 602, an interface 604 capable of communicating with a card reader 602 and configured to accept a transaction card for usage in Personal Identification Number (PIN) verification. The data security apparatus 600 further comprises a processor 616 coupled to the communication interface and a memory 617. The memory 617 is coupled to the processor 616 and contains a computable readable program code capable of causing the processor 616 to verify a PIN. The PIN verification process comprises linking a plurality of cipher blocks in a Cipher Block Chain (CBC), applying an incoming plaintext block derived from a secret Personal Identification Number (PIN) to one of the plurality of cipher blocks, applying an incoming plaintext block derived from a non-secret entity-identifier and ciphertext from a cipher block in the CBC chain, key the plurality of cipher blocks with a secret PIN Verification Key (PVK), and executing the cipher blocks resulting in generation of ciphertext.

Also referring to FIG. 6, the data security apparatus 600 comprises a network 610, one or more servers and/or hosts 612 coupled to the network 610, and one or more terminals 614 coupled to the servers and/or hosts 612 via the network 610. Multiple magnetic stripe cards are typically enrolled in the system and are capable of insertion into the terminals for performing transactions via the servers. Multiple processors 606, 616 are distributed among the servers, hosts, and/or the terminals. At least one of the processors is capable of executing PIN verification using the magnetic stripe card to verify a PIN using information contained in a database 618.

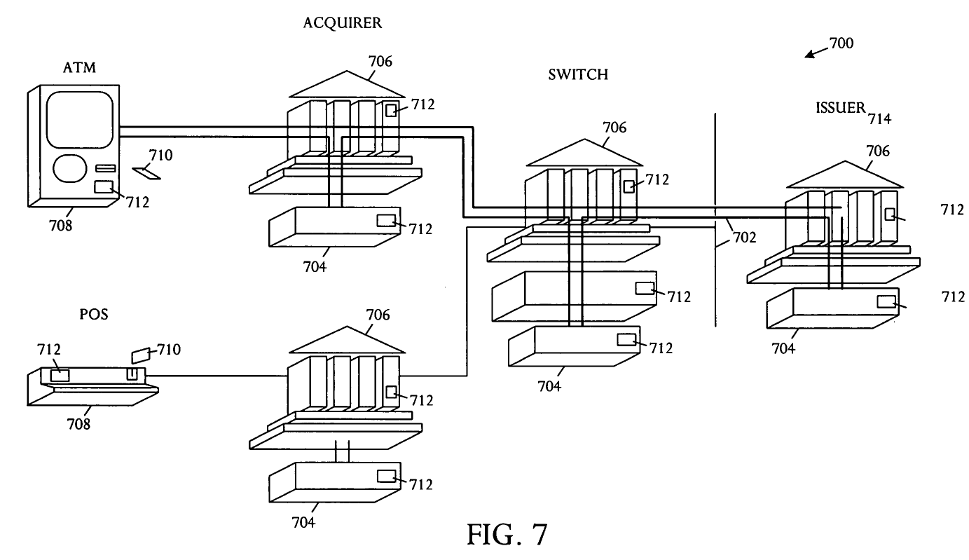

Referring to FIG. 7, a schematic block diagram depicts an embodiment of a transaction system 700 capable of using a magnetic stripe card for Personal Identification Number (PIN) verification. The transaction system 700 comprises a network 702, a plurality of servers 704 and/or hosts 706 coupled to the network 702, and a plurality of terminals 708 coupled to network. The transaction system 700 further comprises a plurality of magnetic stripe cards 710 that are enrolled in the transaction system 700 by an issuer 714 and capable of insertion into the terminals 708 and performing transactions via the servers 704. A plurality of processors 712 are distributed among the servers 704, and/or the terminals 708. At least one of the processors 712 can execute PIN verification using magnetic strip cards 710 as described.

The illustrative embodiments have several characteristics indicative of improved security. The cryptographic algorithm used in the techniques, such as triple-Data Encryption Standard (3-DES) and Advanced Encryption Standard (AES) definition lengthen the key to enable improved security. The illustrative systems and techniques enable usage of all digits of the account number in the verification process, for example using Cipher Block Chaining (CBC) in combination with triple-DES. Combination of the PIN with the account number for usage as direct input entries into the cryptographic algorithm improves security by hiding the secret PIN as early as possible. PIN Verification Value (PVV) data is variable in length and can be decimalized for storage on track 1 and/or track 2 of the magnetic stripe card.

The structure of the illustrative PIN verification techniques is secure in conditions of PIN or account number changes.

The illustrative systems and methods can be implemented using fast techniques such as fast 3-DES operations or very fast key set-up for usage of AES.

While the present disclosure describes various embodiments, these embodiments are to be understood as illustrative and do not limit the claim scope. Many variations, modifications, additions and improvements of the described embodiments are possible. For example, those having ordinary skill in the art will readily implement the steps necessary to provide the structures and methods disclosed herein, and will understand that the process parameters, materials, and dimensions are given by way of example only. The parameters, materials, and dimensions can be varied to achieve the desired structure as well as modifications, which are within the scope of the claims. Variations and modifications of the embodiments disclosed herein may also be made while remaining within the scope of the following claims. For example, although the illustrative techniques and systems are applied using magnetic stripe cards, smart cards may alternatively be used, although the illustrative technique does not employ the full capabilities of a smart card.

1. A Personal Identification Number (PIN) verification apparatus comprising:
a plurality of cipher blocks linked in a Cipher Block Chain (CBC) and keyed with a secret PIN Verification Key (PVK);
a first input block coupled to a first cipher block in the CBC chain capable of receiving a text block derived from a secret Personal Identification Number (PIN); and
a second input block coupled to a second cipher block in the CBC chain capable of receiving a text block derived from a non-secret entity-identifier and ciphertext from a cipher block in the CBC chain.

2. The apparatus according to claim 1 further comprising:
a logical operator that exclusive-ORs the plaintext block derived from the secret PIN with an initialization vector to produce an initialized block;
a first encryptor that encrypts the initialized block using triple Data Encryption Standard (3-DES) encryption to produce a first ciphertext block;
a logical operator that exclusive-ORs the plaintext block derived from the non-secret entity-identifier with the first ciphertext block to produce a chained block; and
a second encryptor that encrypts the chained block using triple Data Encryption Standard (3-DES) encryption to produce a second ciphertext block.

3. The apparatus according to claim 2 wherein:
the PIN verification apparatus operates in a reversible mode that enables recovery of the secret PIN from the second ciphertext block.

4. The apparatus according to claim 2 further comprising:
a logical operator that exclusive-ORs the first ciphertext block with the second ciphertext block to produce a third ciphertext block.

5. The apparatus according to claim 4 wherein:
the PIN verification apparatus operates in an irreversible mode that obstructs recovery of the secret PIN.

6. The apparatus according to claim 5 further comprising:
an escrow storage coupled to the second encryptor and capable of storing the second ciphertext block.

7. The apparatus according to claim 1 further comprising:
the plurality of cipher blocks that encrypt data according to a triple Data Encryption Standard (3-DES).

8. The apparatus according to claim 1 further comprising:
a format converter coupled to a cipher block in the CBC chain and capable of converting hexadecimal digit ciphertext to a decimal result by scanning the hexadecimal digit ciphertext, selecting a predetermined number of numeric digits, and generating output digits as a PIN Verification Value (PVV).

9. The apparatus according to claim 1 further comprising:
the plurality of cipher blocks that encrypt data according to a definition selected from among a group consisting of triple Data Encryption Standard (3-DES) and Advanced Encryption Standard (AES) definition.

10. The apparatus according to claim I further comprising:
a first formatter configured to construct a first incoming plaintext block from a concatenation of a length digit, x hexadecimal digits of the secret Personal Identification Number (PIN) with 16−(x+1) rightmost hexadecimal digits of the non-secret entity-identifier; and
a second formatter configured to construct a second incoming plaintext block from a concatenation of y hexadecimal digits of the non-secret entity-identifier with a pad character that is repeated 16-y times.

11. A method for Personal Identification Number (PIN) verification comprising:
linking a plurality of cipher blocks in a Cipher Block Chain (CBC);
applying an incoming plaintext block derived from a secret Personal Identification Number (PIN) to one of the plurality of cipher blocks;
applying an incoming plaintext block derived from a non-secret entity-identifier and ciphertext from a cipher block in the CBC chain;
keying the plurality of cipher blocks with a secret PIN Verification Key (PVK); and
executing the cipher blocks resulting in generation of ciphertext.

12. The method according to claim 11 further comprising:
a plurality of cipher blocks that encrypt data according to a triple Data Encryption Standard (3-DES).

13. The method according to claim 11 wherein the PIN verification method is capable of operating in a reversible mode that enables recovery of the secret PIN, the method comprising:
exclusive-ORing the plaintext block derived from the secret PIN with an initialization vector to produce an initialized block;
encrypting the initialized block using triple Data Encryption Standard (3-DES) encryption to produce a first ciphertext block;
exclusive-ORing the plaintext block derived from the non-secret entity-identifier with the first ciphertext block to produce a chained block;
encrypting the chained block using triple Data Encryption Standard (3-DES) encryption to produce a second ciphertext block; and
supplying the second ciphertext block for PIN verification.

14. The method according to claim 11 wherein the PIN verification method is capable of operating in an irreversible mode that obstructs recovery of the secret PIN, the method comprising:
exclusive-ORing the plaintext block derived from the secret PIN with an initialization vector to produce an initialized block;
encrypting the initialized block using triple Data Encryption Standard (3-DES) encryption to produce a first ciphertext block;
exclusive-ORing the plaintext block derived from the non-secret entity-identifier with the first ciphertext block to produce a chained block;
encrypting the chained block using triple Data Encryption Standard (3-DES) encryption to produce a second ciphertext block;
exclusive-ORing the first ciphertext block with the second ciphertext block to produce a third ciphertext block; and
supplying the second ciphertext block for PIN verification.

15. The method according to claim 14 further comprising:
storing the second ciphertext block in at least one escrow to facilitate recovery of the secret PIN.

16. The method according to claim 11 further comprising:
converting hexadecimal digit ciphertext generated by a final ciphertext block in the Cipher Block Chain (CBC) to a decimal result by scanning the hexadecimal digit ciphertext, selecting a predetermined number of numeric digits, and generating output digits as a PIN Verification Value (PVV); and
using the PVV for PIN verification.

17. The method according to claim 11 further comprising:
supplying hexadecimal digit ciphertext generated by a final ciphertext block in the Cipher Block Chain (CBC) as a PIN Verification Value (PVV).

18. The method according to claim 11 further comprising:
a plurality of cipher blocks that encrypt data according to a definition selected from among a group consisting of triple Data Encryption Standard (3-DES) and Advanced Encryption Standard (AES) definition.

19. The method according to claim 11 further comprising:
constructing a first incoming plaintext block from a concatenation of a length digit, x hexadecimal digits of the secret Personal Identification Number (PIN) with 16−(x+1) rightmost hexadecimal digits of the non-secret entity-identifier; and
constructing a second incoming plaintext block from a concatenation of y hexadecimal digits of the non-secret entity-identifier with a pad character that is repeated 16-y times.

20. A data security apparatus comprising:
an enrollment terminal capable of accepting a magnetic stripe card storing a non-secret entity-identifier and an entity-selected secret Personal Identification Number (PIN);
a processor coupled to the enrollment terminal and capable of receiving the entity-identifier and the PIN; and
a memory coupled to the processor and having a computable readable program code embodied therein capable of causing the processor to enroll a PIN comprising linking a plurality of cipher blocks in a Cipher Block Chain (CBC), applying an incoming plaintext block derived from the secret Personal Identification Number (PIN) to one of the plurality of cipher blocks, applying an incoming plaintext block derived from the non-secret entity-identifier and ciphertext from a cipher block in the CBC chain, keying the plurality of cipher blocks with a secret PIN Verification Key (PVK), and executing the cipher blocks resulting in generation of ciphertext PIN Verification Value (PVV) for usage in performing a subsequent PIN verification function.

21. The apparatus according to claim 20 wherein the PIN verification function is capable of operating in a reversible mode that enables recovery of the secret PIN and the memory further comprises:
a computable readable program code capable of causing the processor to exclusive-OR the plaintext block derived from the secret PIN with an initialization vector to produce an initialized block;
a computable readable program code capable of causing the controller to encrypt the initialized block using triple Data Encryption Standard (3-DES) encryption to produce a first ciphertext block;
a computable readable program code capable of causing the controller to exclusive-OR the plaintext block derived from the non-secret entity-identifier with the first ciphertext block to produce a chained block;
a computable readable program code capable of causing the controller to encrypt the chained block using triple Data Encryption Standard (3-DES) encryption to produce a second ciphertext block; and
a computable readable program code capable of causing the controller to supply the second ciphertext block for PIN verification.

22. The apparatus according to claim 20 wherein the PIN verification function is capable of operating in an irreversible mode that obstructs recovery of the secret PIN and the memory further comprises:
a computable readable program code capable of causing the processor to exclusive-OR the plaintext block derived from the secret PIN with an initialization vector to produce an initialized block;
a computable readable program code capable of causing the controller to encrypt the initialized block using triple Data Encryption Standard (3-DES) encryption to produce a first ciphertext block;
a computable readable program code capable of causing the controller to exclusive-OR the plaintext block derived from the non-secret entity-identifier with the first ciphertext block to produce a chained block;
a computable readable program code capable of causing the controller to encrypt the chained block using triple Data Encryption Standard (3-DES) encryption to produce a second ciphertext block;
a computable readable program code capable of causing the controller to exclusive-OR the first ciphertext block with the second ciphertext block to produce a third ciphertext block; and
a computable readable program code capable of causing the controller to supply the second ciphertext block for PIN verification.

23. The apparatus according to claim 22 further comprising:
an escrow storage communicatively coupled to the transaction system and comprising at least one escrow storage element; and
the memory further comprises a computable readable program code capable of causing the processor to store the second ciphertext block in the escrow storage in at least one secret escrow share to facilitate recovery of the secret PIN.

24. The apparatus according to claim 20 wherein the memory further comprises:
a computable readable program code capable of causing the processor to convert hexadecimal digit ciphertext generated by a final ciphertext block in the Cipher Block Chain (CBC) to a decimal result by scanning the hexadecimal digit ciphertext, selecting a predetermined number of numeric digits, and generating output digits as a PIN Verification Value (PVV); and
a computable readable program code capable of causing the processor to write the PVV to a magnetic stripe card or a smart card.

25. The apparatus according to claim 20 wherein the memory further comprises:
a computable readable program code capable of causing the processor to store hexadecimal digit ciphertext generated by a final ciphertext block in the Cipher Block Chain (CBC) as a PIN Verification Value (PVV) in a storage element.

26. The apparatus according to claim 20 wherein:
the plurality of cipher blocks encrypt data according to a definition selected from among a group consisting of triple Data Encryption Standard (3-DES) and Advanced Encryption Standard (AES) definition.

27. The apparatus according to claim 20 wherein the memory further comprises:
a computable readable program code capable of causing the processor to construct a first incoming plaintext block from a concatenation of a length digit and x hexadecimal digits of the secret Personal Identification Number (PIN) with 16−(x+1) rightmost hexadecimal digits of the non-secret entity-identifier; and
a computable readable program code capable of causing the processor to construct a second incoming plaintext block from a concatenation of y hexadecimal digits of the non-secret entity-identifier with a pad character that is repeated 16-y times.

28. A data security apparatus comprising:
a PIN Verification Value (PVV) database capable of storing a plurality of PIN Verification Values (PVVs) for enrolled magnetic stripe cards;
an escrow capable of storing a plurality of escrow values associated with at least some of the enrolled magnetic stripe cards; and
a processor coupled to the PVV database and the escrow and capable of receiving an entity-identifier, a PIN Verification Value (PVV) associated to the entity-identifier, and at least one escrow value associated to the entity-identifier; and
a memory coupled to the processor and having a computable readable program code embodied therein capable of causing the processor to recover a PIN comprising linking a plurality of cipher blocks in a Cipher Block Chain (CBC), applying an incoming plaintext block derived from the PIN Verification Value (PVV) to one of the plurality of cipher blocks, applying an incoming plaintext block derived from the non-secret entity-identifier and ciphertext from a cipher block in the CBC chain, keying the plurality of cipher blocks with a secret PIN Verification Key (PVK), executing the cipher blocks to produce a ciphertext value, and combining the ciphertext value with the at least one escrow value resulting in recovery of the PIN verification function.

29. A data security apparatus comprising:
a transaction terminal capable of accepting a magnetic stripe card storing a non-secret entity-identifier and an entity-entered secret Personal Identification Number (PIN);
a PIN Verification Value (PVV) database;
a processor communicatively coupled to the transaction terminal and capable of receiving the entity-identifier, the PIN′, and coupled to the PVV database and capable of retrieving a PIN Verification Value (PVV) associated with the entity-identifier; and
a memory coupled to the processor and having a computable readable program code embodied therein capable of causing the processor to verify the PIN′ comprising linking a plurality of cipher blocks in a Cipher Block Chain (CBC), applying an incoming plaintext block derived from the secret entered Personal Identification Number (PIN) to one of the plurality of cipher blocks, applying an incoming plaintext block derived from the non-secret entity-identifier and ciphertext from a cipher block in the CBC chain, keying the plurality of cipher blocks with a secret PIN Verification Key (PVK), executing the cipher blocks resulting in generation of ciphertext transaction PIN Verification Value (PVV); comparing the generated PVV′ and the retrieved PVV; and determining PIN verification based on the comparison.

30. A transaction system comprising:
a network;
a plurality of servers and/or hosts coupled to the network;
a plurality of terminals coupled to the servers via the network;
a plurality of magnetic stripe cards enrolled in the transaction system and capable of insertion into the on-line terminals and performing transactions via the servers; and
a plurality of processors distributed among the servers, hosts, and/or the terminals, at least one of the processors being capable of executing PIN verification using a magnetic stripe card and having a computable readable program code embodied therein capable of causing the processor to link a plurality of cipher blocks in a Cipher Block Chain (CBC), apply an incoming plaintext block derived from a secret Personal Identification Number (PIN) to one of the plurality of cipher blocks, apply an incoming plaintext block derived from a non-secret entity-identifier and ciphertext from a cipher block in the CBC chain, key the plurality of cipher blocks with a secret PIN Verification Key (PVK), and execute the cipher blocks resulting in generation of ciphertext.

31. A data security apparatus comprising:
means for enrolling a transaction card in a data system; and
means for generating a Personal Identification Number (PIN) Verification Value (PVV) for usage in Personal Identification Number (PIN) verification further comprising:
means for linking a plurality of cipher blocks in a Cipher Block Chain (CBC);
means for applying an incoming plaintext block derived from a secret Personal Identification Number (PIN) to one of the plurality of cipher blocks;
means for applying an incoming plaintext block derived from a non-secret entity-identifier to another of the plurality of cipher blocks;
means for keying the plurality of cipher blocks with a secret PIN Verification Key (PVK); and
means for generating a PIN Verification Value (PVV) via operation of a plurality of cipher blocks in the Cipher Block Chain; and
means for writing the PVV to a transaction card for subsequent PIN verification.
